(19) United States
(12) Patent Application Publication
(10) Pub. No.: US 2023/0345242 A1
(43) Pub. Date: Oct. 26, 2023

(54) METHODS AND APPARATUSES FOR SECURITY IN MARITIME COMMUNICATION

(71) Applicant: Telefonaktiebolaget LM Ericsson (publ), Stockholm (SE)

(72) Inventors: Tianyi LI, Shanghai (CN); Shunqi LUAN, Shanghai (CN); Zhaohua CHEN, Beijing (CN)

(21) Appl. No.: 18/036,545

(22) PCT Filed: Feb. 7, 2021
(86) PCT No.: PCT/CN2021/075797

§ 371 Date: May 11, 2023

(51) Int. Cl. H04W 12/06; H04W 12/63; H04W 12/69

(52) U.S. Cl. CPC H04W 12/06; H04W 12/63; H04W 12/69

(57) ABSTRACT

A management server predicts future locations of a plurality of maritime vessels based on historical status information of the plurality of maritime vessels. The plurality of maritime vessels include a first maritime vessel and a second maritime vessel. The first maritime vessel is communicatively connected to a terrestrial network via the second maritime vessel. The management server determines whether a disconnection between the first and second maritime vessels is to occur, based on the predicted future locations of the first and second maritime vessels. In response to determining that the disconnection is to occur, the management server obtains, from the first maritime vessel, security related information of the first maritime vessel before the disconnection occurs. When the first maritime vessel reconnects to the terrestrial network, the management server performs a first authorization process for the first maritime vessel based on the obtained security related information of the first maritime vessel.

### TECHNICAL FIELD

Embodiments of the disclosure generally relate to communication, and, more particularly, to methods and apparatuses for security in maritime communication.

### BACKGROUND

This section introduces aspects that may facilitate better understanding of the present disclosure. Accordingly, the statements of this section are to be read in this light and are not to be understood as admissions about what is in the prior art or what is not in the prior art.

Typically, a maritime vessel communicates with remote communication devices via terrestrial networks, or satellite networks when the maritime vessel is out of reach of the terrestrial networks or in other special conditions. For instance, when out of range of the terrestrial networks, machine-to-machine (M2M) devices on a maritime vessel may connect to a base station on the maritime vessel, which in turn is connected via a satellite network to a core network somewhere on land. The connection decision is based on the vessel's proximity to the terrestrial networks.

In the above typical solution, the maritime vessels, however, do not take advantage of other maritime vessels in close proximity to create opportunities for more cost effective and efficient communication therebetween and, ultimately, to the terrestrial networks. Also, it is not uncommon for a maritime vessel to lose satellite connectivity because the heading of the maritime vessel is such that a line of sight to the satellite from the satellite communication equipment onboard the maritime vessel becomes blocked by structures onboard the maritime vessel. Besides, limited by the technique, the satellite network cannot provide high speed service, like file transfer or video. Additionally, the typical solution does not take into account national jurisdictions with respect to the location of the maritime vessels, and associated potential ad hoc networks, to send and receive information both legally and efficiently.

Despite continued efforts to improve communication and reduce communication costs for a maritime vessel, a system is needed to mitigate the substantial hindrances for reliable radio communication from the maritime vessel to external networks such as the terrestrial networks.

In particular, with respect to authentication and authorization, according to 3rd generation partnership project (3GPP) technical specification (TS) 33.501, the 4th generation (4G)/5th generation (5G) system shall satisfy the following requirements.
Subscription authentication: The serving network shall authenticate international mobile subscriber identity (IMSI) or the subscription permanent identifier (SUPI) in the process of authentication and key agreement between user equipment (UE) and network.
Serving network authentication: The UE shall authenticate the serving network identifier through implicit key authentication.
UE authorization: The serving network shall authorize the UE through the subscription profile obtained from the home network. UE authorization is based on the authenticated SUPI.
Serving network authorization by the home network: Assurance shall be provided to the UE that it is connected to a serving network that is authorized by the home network to provide services to the UE. This authorization is ‘implicit’ in the sense that it is implied by a successful authentication and key agreement run.
Access network authorization: Assurance shall be provided to the UE that it is connected to an access network that is authorized by the serving network to provide services to the UE. This authorization is ‘implicit’ in the sense that it is implied by a successful establishment of access network security. This access network authorization applies to all types of access networks.
Unauthenticated Emergency Services: In order to meet regulatory requirements in some regions, the 4G/5G system shall support unauthenticated access for emergency services. This requirement applies to all mobile equipments (MEs) and only to those serving networks where regulatory requirements for unauthenticated emergency services exist. Serving networks located in regions where unauthenticated emergency services are forbidden shall not support this feature.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for security in maritime communication. In particular, one of the problems to be solved by the disclosure is that the existing solution may result in authentication and authorization storm when a disconnection occurs between some maritime vessels.

According to a first aspect of the disclosure, there is provided a method performed by a management server. The method may comprise predicting future locations of a plurality of maritime vessels based on historical status information of the plurality of maritime vessels. The plurality of maritime vessels may comprise a first maritime vessel and a second maritime vessel. The first maritime vessel may be communicatively connected to a terrestrial network via the second maritime vessel. The method may further comprise determining whether a disconnection between the first and second maritime vessels is to occur, based on the predicted future locations of the first and second maritime vessels. The method may further comprise, in response to determining that the disconnection is to occur, obtaining, from the first maritime vessel, security related information of the first maritime vessel before the disconnection occurs. The method may further comprise, when the first maritime vessel reconnects to the terrestrial network, performing a first authorization process for the first maritime vessel based on the obtained security related information of the first maritime vessel.

In this way, it is possible to reduce the signaling overhead required for authorization of the first maritime vessel.

In an embodiment of the disclosure, the method may further comprise, in response to determining that the disconnection is to occur, determining, from the plurality of maritime vessels, a third maritime vessel via which the first maritime vessel can reconnect to the terrestrial network, based on the predicted future locations of the plurality of maritime vessels. The method may further comprise sending identification information of the third maritime vessel to the first maritime vessel.

In an embodiment of the disclosure, the security related information of the first maritime vessel may comprise authorization information of the first maritime vessel. Performing the first authorization process for the first maritime vessel may comprise verifying whether the obtained authorization information of the first maritime vessel is still valid. Performing the first authorization process for the first maritime vessel may further comprise, when the obtained authorization information of the first maritime vessel is still valid, sending, to the first maritime vessel, the obtained authorization information of the first maritime vessel.

In an embodiment of the disclosure, the security related information of the first maritime vessel may comprise authentication information of the first maritime vessel. Performing the first authorization process for the first maritime vessel may comprise receiving, from the first maritime vessel, a request for authorization of the first maritime vessel. The request may comprise identity proof information of the first maritime vessel. Performing the first authorization process for the first maritime vessel may further comprise verifying the identity proof information of the first maritime vessel based on the obtained authentication information of the first maritime vessel.

In an embodiment of the disclosure, the plurality of maritime vessels may comprise one or more fourth maritime vessels which are communicatively connected to the terrestrial network via the first maritime vessel. The method may further comprise, in response to determining that the disconnection is to occur, obtaining security related information of the one or more fourth maritime vessels before the disconnection occurs. The method may further comprise, when at least one of the more or more fourth maritime vessels reconnects to the terrestrial network via the first maritime vessel, performing a second authorization process for the at least one fourth maritime vessel based on the obtained security related information of the at least one fourth maritime vessel.

In an embodiment of the disclosure, the security related information of the one or more fourth maritime vessels may comprise authorization information of the one or more fourth maritime vessels. Performing the second authorization process for the at least one fourth maritime vessel may comprise verifying whether the obtained authorization information of the at least one fourth maritime vessel is still valid. Performing the second authorization process for the at least one fourth maritime vessel may further comprise, when the obtained authorization information of the at least one fourth maritime vessel is still valid, sending, to the first maritime vessel, a grant for restoring a secure connection between the first maritime vessel and the at least one fourth maritime vessel.

In an embodiment of the disclosure, the identity proof information of the first maritime vessel may comprise a digital signature signed by the first maritime vessel.

In an embodiment of the disclosure, there may be a chain of maritime vessels including the first maritime vessel and an anchor maritime vessel directly connected to the terrestrial network. The security related information of each maritime vessel on the chain may be contained in a block body of a corresponding block of a blockchain. A block header of the corresponding block may contain a hash value of a previous block header.

In an embodiment of the disclosure, identity proof information of a maritime vessel on the chain may comprise a block header of a corresponding block of the blockchain.

In an embodiment of the disclosure, the future locations of the plurality of maritime vessels may be predicted by using a mobility tracking process.

In an embodiment of the disclosure, the future locations of the plurality of maritime vessels may be predicted by using a machine learning process.

In an embodiment of the disclosure, the machine learning process may comprise a clustering process.

In an embodiment of the disclosure, the historical status information of the plurality of maritime vessels may comprise: historical positioning information of the plurality of maritime vessels; and/or historical reception signal strength of the plurality of maritime vessels.

According to a second aspect of the disclosure, there is provided a method performed by a first server on a first maritime vessel. The first maritime vessel may be communicatively connected to a terrestrial network via a second maritime vessel. The method may comprise, in response to a trigger event indicating that a disconnection between the first and second maritime vessels is to occur, providing, to a management server, security related information of the first maritime vessel before the disconnection occurs. The method may further comprise, when the first maritime vessel reconnects to the terrestrial network, sending, to the management server, a request for authorization of the first maritime vessel. The method may further comprise receiving, from the management server, a response to the request.

In this way, it is possible to reduce the signaling overhead required for authorization of the first maritime vessel.

In an embodiment of the disclosure, the method may further comprise, in response to the trigger event, receiving, from the management server, identification information of a third maritime vessel via which the first maritime vessel can reconnect to the terrestrial network.

In an embodiment of the disclosure, the security related information of the first maritime vessel may comprise authorization information of the first maritime vessel. The response to the request may comprise the authorization information of the first maritime vessel that is provided to the management server by the first server.

In an embodiment of the disclosure, the security related information of the first maritime vessel may comprise authentication information of the first maritime vessel. The request may comprise identity proof information of the first maritime vessel.

In an embodiment of the disclosure, one or more fourth maritime vessels may be communicatively connected to the terrestrial network via the first maritime vessel. The method may further comprise: in response to the trigger event, providing security related information of the one or more fourth maritime vessels to the management server before the disconnection occurs.

In an embodiment of the disclosure, the request may further indicate that at least one of the more or more fourth maritime vessels requires authorization by the management server.

In an embodiment of the disclosure, the security related information of the one or more fourth maritime vessels may comprise authorization information of the one or more fourth maritime vessels. The response to the request may comprise a grant for restoring a secure connection between the first maritime vessel and the at least one fourth maritime vessel.

In an embodiment of the disclosure, the method may further comprise, in response to the grant, obtaining, from the at least one fourth maritime vessel, authorization information of the at least one fourth maritime vessel. The method may further comprise performing a verification process for the authorization information of the at least one fourth maritime vessel.

In an embodiment of the disclosure, the authorization information of the at least one fourth maritime vessel may be received in an unencrypted form.

In an embodiment of the disclosure, the authorization information of each of the at least one fourth maritime vessel may be respectively received from corresponding fourth maritime vessel in an encrypted form. Performing the verification process may comprise decrypting the authorization information of each of the at least one fourth maritime vessel based on the grant from the management server.

In an embodiment of the disclosure, the encrypted form may be obtained by a public key of the corresponding fourth maritime vessel. The authorization information of each of the at least one fourth maritime vessel may be decrypted based on a private key of the corresponding fourth maritime vessel.

In an embodiment of the disclosure, the identity proof information of the first maritime vessel may comprise a digital signature signed by the first maritime vessel.

In an embodiment of the disclosure, there may be a chain of maritime vessels including the first maritime vessel and an anchor maritime vessel directly connected to the terrestrial network. The security related information of each maritime vessel on the chain may be contained in a block body of a corresponding block of a blockchain. A block header of the corresponding block may contain a hash value of a previous block header.

In an embodiment of the disclosure, identity proof information of a maritime vessel on the chain may comprise a block header of a corresponding block of the blockchain.

According to a third aspect of the disclosure, there is provided a management server. The management server may comprise at least one processor and at least one memory. The at least one memory may contain instructions executable by the at least one processor, whereby the management server may be operative to predict future locations of a plurality of maritime vessels based on historical status information of the plurality of maritime vessels. The plurality of maritime vessels may comprise a first maritime vessel and a second maritime vessel. The first maritime vessel may be communicatively connected to a terrestrial network via the second maritime vessel. The management server may be further operative to determine whether a disconnection between the first and second maritime vessels is to occur, based on the predicted future locations of the first and second maritime vessels. The management server may be further operative to, in response to determining that the disconnection is to occur, obtain, from the first maritime vessel, security related information of the first maritime vessel before the disconnection occurs. The management server may be further operative to, when the first maritime vessel reconnects to the terrestrial network, perform a first authorization process for the first maritime vessel based on the obtained security related information of the first maritime vessel.

In an embodiment of the disclosure, the management server may be operative to perform the method according to the above first aspect.

According to a fourth aspect of the disclosure, there is provided a first server on a first maritime vessel. The first maritime vessel may be communicatively connected to a terrestrial network via a second maritime vessel. The first server may comprise at least one processor and at least one memory. The at least one memory may contain instructions executable by the at least one processor, whereby the first server may be operative to, in response to a trigger event indicating that a disconnection between the first and second maritime vessels is to occur, provide, to a management server, security related information of the first maritime vessel before the disconnection occurs. The first server may be further operative to, when the first maritime vessel reconnects to the terrestrial network, send, to the management server, a request for authorization of the first maritime vessel. The first server may be further operative to receive, from the management server, a response to the request.

In an embodiment of the disclosure, the first server may be operative to perform the method according to the above second aspect.

According to a fifth aspect of the disclosure, there is provided a computer program product. The computer program product may comprise instructions which when executed by at least one processor, cause the at least one processor to perform the method according to any of the above first and second aspects.

According to a sixth aspect of the disclosure, there is provided a computer readable storage medium. The computer readable storage medium may comprise instructions which when executed by at least one processor, cause the at least one processor to perform the method according to any of the above first and second aspects.

According to a seventh aspect of the disclosure, there is provided a management server. The management server may comprise a prediction module for predicting future locations of a plurality of maritime vessels based on historical status information of the plurality of maritime vessels. The plurality of maritime vessels may comprise a first maritime vessel and a second maritime vessel. The first maritime vessel may be communicatively connected to a terrestrial network via the second maritime vessel. The management server may further comprise a determination module for determining whether a disconnection between the first and second maritime vessels is to occur, based on the predicted future locations of the first and second maritime vessels. The management server may further comprise an obtaining module for, in response to determining that the disconnection is to occur, obtaining, from the first maritime vessel, security related information of the first maritime vessel before the disconnection occurs. The management server may further comprise an authorization module for, when the first maritime vessel reconnects to the terrestrial network, performing a first authorization process for the first maritime vessel based on the obtained security related information of the first maritime vessel.

According to an eighth aspect of the disclosure, there is provided a first server on a first maritime vessel. The first maritime vessel may be communicatively connected to a terrestrial network via a second maritime vessel. The first server may comprise a provision module for, in response to a trigger event indicating that a disconnection between the first and second maritime vessels is to occur, providing, to a management server, security related information of the first maritime vessel before the disconnection occurs. The first server may further comprise a sending module for, when the first maritime vessel reconnects to the terrestrial network, sending, to the management server, a request for authorization of the first maritime vessel. The first server may further comprise a reception module for receiving, from the management server, a response to the request.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a scenario of maritime communication;

FIG. 2 is a diagram illustrating an exemplary communication system into which an embodiment of the disclosure is applicable;

FIG. 3 is a diagram illustrating another exemplary communication system into which an embodiment of the disclosure is applicable;

FIGS. 4A-4B are diagrams illustrating a scenario in which an embodiment of the disclosure is applicable;

FIG. 5 is a flowchart illustrating a method performed by a management server according to an embodiment of the disclosure;

FIG. 6 is a diagram illustrating an architecture for location prediction using machine learning;

FIG. 7 is a flowchart for explaining the method of FIG. 5;

FIGS. 8A-8B are diagrams for explaining the principle of blockchain;

FIGS. 9A-9B are diagrams illustrating exemplary blockchains usable in the present disclosure;

FIG. 10 is a flowchart illustrating a method performed by a management server according to an embodiment of the disclosure;

FIG. 11 is a flowchart illustrating a method performed by a management server according to an embodiment of the disclosure;

FIG. 12 is a flowchart for explaining the method of FIG. 11;

FIG. 13 is a flowchart illustrating a method performed by a first server according to an embodiment of the disclosure;

FIG. 14 is a flowchart illustrating a method performed by a first server according to an embodiment of the disclosure;

FIG. 15 is a flowchart illustrating a method performed by a first server according to an embodiment of the disclosure;

FIG. 16 is a diagram illustrating an exemplary process according to an embodiment of the disclosure;

FIG. 17 is a diagram illustrating an exemplary process according to an embodiment of the disclosure;

FIG. 18 is a diagram illustrating an exemplary process according to an embodiment of the disclosure;

FIG. 19 is a diagram illustrating an exemplary process according to an embodiment of the disclosure;

FIG. 20 is a block diagram showing an apparatus suitable for use in practicing some embodiments of the disclosure;

FIG. 21 is a block diagram showing a management server according to an embodiment of the disclosure; and

FIG. 22 is a block diagram showing a first server according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

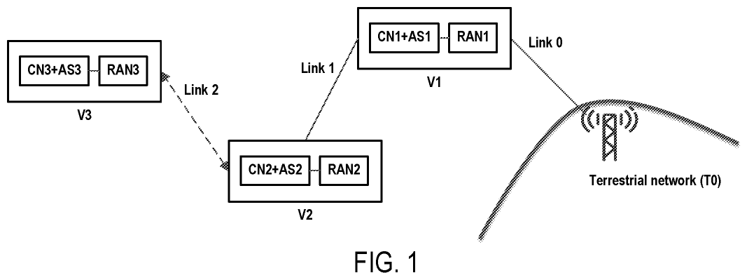

FIG. 1 is a diagram illustrating an exemplary scenario of maritime communication. As shown, there are three maritime vessels each of which is provided with a radio access network (RAN), a core network (CN) and an applications server (AS). These vessels may be connected to form a maritime network. The vessel V2 has connected to the terrestrial network T0 via the vessel V1. During the initial registration of the vessel V3 to the maritime network, there are some steps from the security part. At the first step, a UE on the vessel V3 performs subscription authentication with the home network via the vessel V2. The terrestrial network T0, or the vessel V1 which is an anchor node directly connected to the terrestrial network, may act as the home network.

In the following discussion, suppose the home network is the terrestrial network T0. At the second step, the UE requests authorization with the home network T0. At the third step, access network authorization is performed between the UE and the RAN2. At the fourth step, authorization for serving networks (e.g. those on the vessels V2 and V1) on the chain to the home network T0 is performed by the home network T0. At last, unauthenticated emergency services may be performed between the vessel V3 and the home network T0 via the vessel V2. In addition, if the network is service based architecture (SBA)/clould-native-based microservice architecture, the authentication, authorization and accounting (AAA) center (such as network exposure function (NEF) internally, or NEF externally) should also follow the description above using OAuth-based authorization mechanism. The specific details of the authorization mechanism are given in OAuth 2.0 Framework request for comments (RFC) serials.

There may be the following issues with the existing solution. Firstly, the fourth step mentioned above is not achieved in traditional terrestrial networks. It is neither achieved via application layer nor achieved via lower layers. Secondly, in chain redirection scenario (for example, suppose V3 has lots of connected previous hops such as V4, V5, . . . Vn (not shown in FIG. 1) and V3 disconnects from another chain due to mobility and connects to the chain of V2-V1-T0), there may be authentication and authorization storm. Thirdly, during node level AAA, security flaw such as cyber spoofing, man-in-the-middle (MITM) attack, distributed denial of service (DDOS)/address resolution protocol (ARP) attack, would be utilized by possible attackers. Therefore, it would be desirable to provide a mobility based intelligent AAA solution to mitigate and optimize at least some of the issues mentioned above.

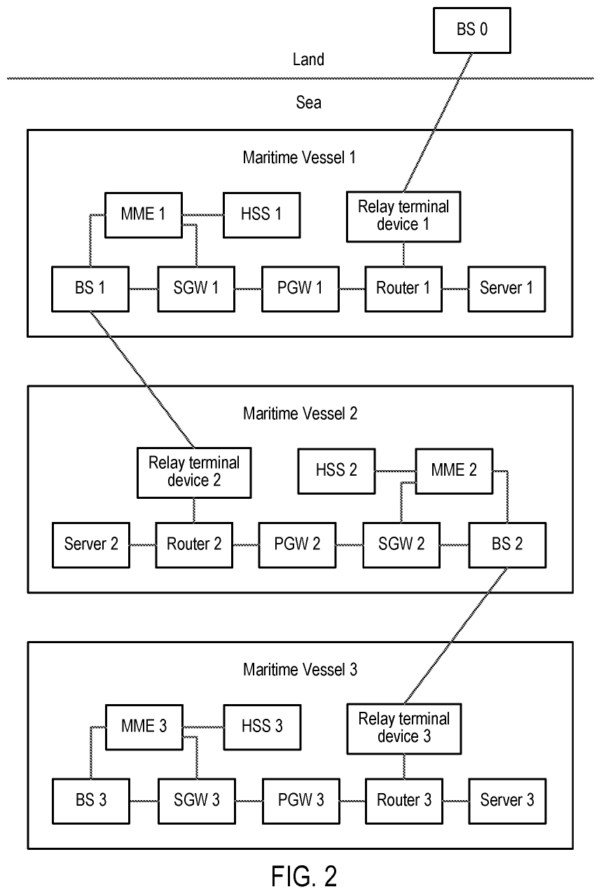

The present disclosure proposes an improved solution for security in maritime communication. Hereinafter, the solution will be described in detail with reference to FIGS. 2-22.

FIG. 2 is a diagram showing an exemplary communication system into which an embodiment of the disclosure is applicable. As shown, the communication system comprises a base station on land and three maritime vessels (Maritime vessel 1, Maritime vessel 2 and Maritime vessel 3). Each maritime vessel comprises a base station, a mobility management entity (MME), a serving gateway (SGW), a packet data network (PDN) gateway (PGW), a home subscriber server (HSS), a router, a relay terminal device and a server (e.g. an application server or a mesh server). The base station can provide radio access communication links to terminal devices that are within its communication service cell. Examples of the base station may include, but not limited to, an evolved node B (eNB), a next generation node B (gNB), etc. For example, in a case where an eNB is deployed at a maritime vessel, when compared with using other technologies such as WiFi to provide access for another maritime vessel, a super maritime wireless network with extended coverage (>100 km) can be provided without enhancement of terrestrial base stations. Only the base station on land is shown for brevity to represent the terrestrial network. The MME, the SGW, the PGW and the HSS are merely exemplary components of the core network for illustration purpose. Some components of the core network may be omitted for brevity. Some additional network elements such as an enterprise network management (ENM), an automatic identification system (AIS) system and an operation support system (OSS) may also be contained in the communication system. Although the core network is shown as part of an evolved packet core (EPC), any other suitable core network such as 5th generation core (5GC) may be used as the core network. Thus, the specific terms used herein do not limit the present disclosure only to the communication system related to the specific terms, which however can be more generally applied to other communication systems. The term mesh server may refer to a server which employs at least some aspect (e.g. peer discovering) of mesh technology. Although three maritime vessels are shown, the number of the maritime vessels may be two or more than three. The terms “maritime vessel” and “ship” may be interchangeably used herein. The number of each entity mentioned above in the maritime vessel may be more than one.

The relay terminal device 1 at Maritime vessel 1 can access the base station 0 on land and also act as an access point for other terminal device(s) at Maritime vessel 1. For example, any one of the relay terminal devices shown in FIG. 2 may be a customer premise equipment (CPE) capable of converting signals of one radio access technology (RAT) to signals of another RAT, such as converting LTE signals to WiFi signals. It is also possible that other terminal device(s) at Maritime vessel 1 may directly access the base station 0 on land. The relay terminal device 1 can be configured not to access the base station 1. The relay terminal device 1 can also relay traffic (e.g. data and/or signaling) between the core network 1 or the server 1 at Maritime vessel 1 and the terrestrial network. The router 1 at Maritime vessel 1 can route traffic between the core network 1, the relay terminal device 1 and the server 1 at Maritime vessel 1.

Similarly, the relay terminal device 2 at Maritime vessel 2 can access the base station 1 at Maritime vessel 1 and also act as an access point for other terminal device(s) at Maritime vessel 2. The relay terminal device 2 can be configured not to access the base station 2. The relay terminal device 2 can also relay traffic between the core network 2 or the server 2 at Maritime vessel 2 and the core network 1 or the server 1 at Maritime vessel 1. The router 2 at Maritime vessel 2 can route traffic between the core network 2, the relay terminal device 2 and the server 2 at Maritime vessel 2.

Likewise, the relay terminal device 3 at Maritime vessel 3 can access the base station 2 at Maritime vessel 2 and also act as an access point for other terminal device(s) at Maritime vessel 3. The relay terminal device 3 can be configured not to access the base station 3. The relay terminal device 3 can also relay traffic between the core network 3 or the server 3 at Maritime vessel 3 and the core network 2 or the server 2 at Maritime vessel 2. The router 3 at Maritime vessel 3 can route traffic between the core network 3, the relay terminal device 3 and the server 3 at Maritime vessel 3. In this way, a multi-hop network can be formed with the topology and coverage being self-organized.

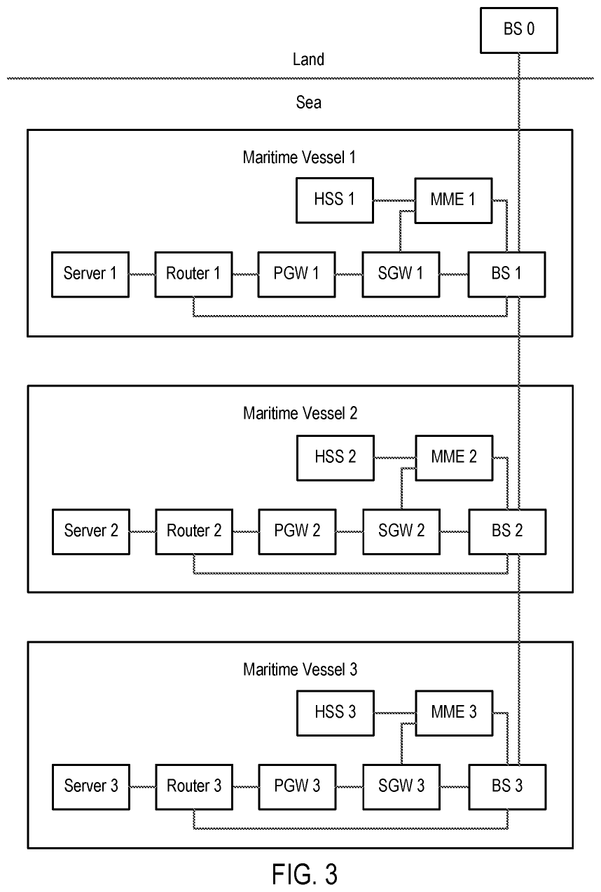

Although embodiments of the disclosure will be described hereinafter with reference to FIG. 2, the present disclosure may also be applied to any other suitable maritime communication system. For example, FIG. 3 illustrates another exemplary communication system into which an embodiment of the disclosure is applicable. In this communication system, each vessel comprises a special base station and a server. The special base station owns base station functionality and user terminal functionality. The special base station in a ship can be used to set up radio connection with another special base station in another ship and the special base station can provide radio connection to the local users in the same ship and the other special base station in the other ship. Within the base stations and the core networks on the ships, the signaling and service data information can be forwarded between each other. In this way, a wireless backhaul path to the base station in terrestrial network can be set up for the special base stations in different ships and communication information can be relayed to/from terrestrial network. The servers on different ships can connect with each other via the special base stations.

The term terminal device may also be referred to as, for example, device, access terminal, user terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

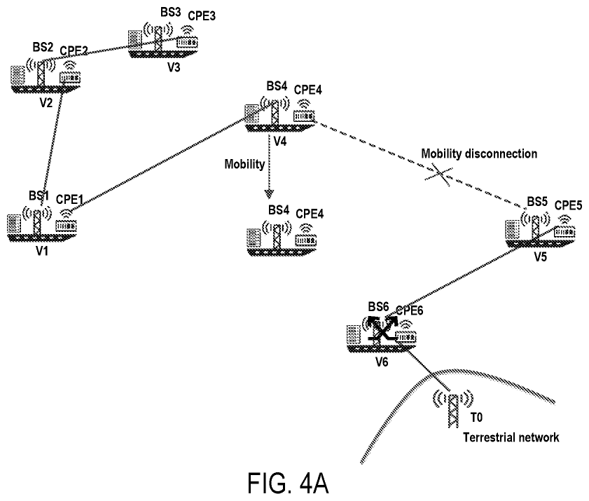

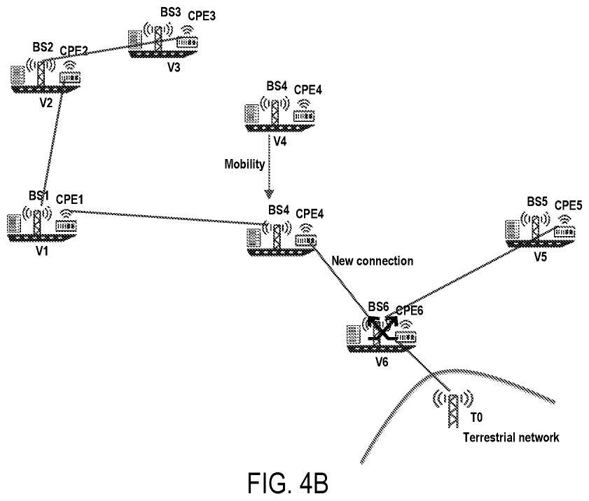

For ease of understanding, FIGS. 4A-4B illustrate an exemplary scenario in which an embodiment of the disclosure is applicable. As shown, the maritime network comprises 6 maritime vessels which constitute a chain of V3-V2-V1-V4-V5-V6. When a disconnection between V4 and V5 happens due to mobility of V4, V1, V2 and V3 may have a longer time of disconnection (e.g. larger than some seconds/minutes) in application layer and transport layer, which may be not acceptable. As shown in FIG. 4B, if V4 begins a new (or reestablishment) connection to the next hop V6, the authentication and authorization behaviors of previous nodes/hops (e.g. V1/V2/V3) may bring a message storm. This case may be more serious in bad radio condition scenario, which is relevant to the speed/radio quality of V4.

In addition, from security view, assume that some attacker may disguise itself as fake V1/V2/V3 that tries to connect V6 or other nodes. By spoofing as mesh server or network functions (NFs), the attacker may have opportunities to disguise itself as an AAA server that tries to manipulate previous nodes (e.g. V1/V2/V3). Furthermore, by implanting Trojan or using some other cyber-attack methods, DDOS may happen on this chain, etc.

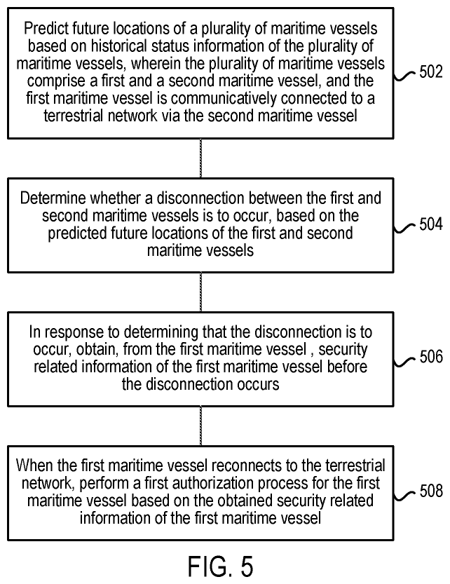

FIG. 5 is a flowchart illustrating a method performed by a management server according to an embodiment of the disclosure. The method is applicable to a communication network including a maritime network and a terrestrial network. The maritime network may comprise multiple maritime vessels each of which is provided with a base station and a server. The management server may have the functionality of an AAA center or security center. For example, the server on the maritime vessel (e.g. V6 in the example of FIGS. 4A-4B) directly connected with the terrestrial network, or a server on land or a fixed offshore platform, may act as the management server.

At block 502, the management server predicts future locations of a plurality of maritime vessels based on historical status information of the plurality of maritime vessels. The plurality of maritime vessels comprise a first maritime vessel (e.g. V4 in FIGS. 4A-4B) and a second maritime vessel (e.g. V5 in FIGS. 4A-4B), and the first maritime vessel is communicatively connected to the terrestrial network via the second maritime vessel. The plurality of maritime vessels may be all of the multiple maritime vessels in the maritime network, or may be only a portion thereof. For example, if a relatively larger number of maritime vessels connect to the terrestrial network via some maritime vessel(s), then the maritime vessel(s) and neighboring maritime vessels thereof may be selected as the plurality of maritime vessels. The historical status information of the plurality of maritime vessels may at least comprise historical positioning information of the plurality of maritime vessels. Examples of the positioning information of a maritime vessel include, but not limited to, geographical location information such as global navigation satellite system (GNSS) information, moving status such as speed and direction (e.g. heading), distance between ships, and the like. The positioning information may be obtained from an AIS deployed at the maritime vessel.

The historical status information of the plurality of maritime vessels may further comprise historical reception signal strength of the plurality of maritime vessels. For example, the reception signal strength may be expressed as reference signal receiving power (RSRP) or reference signal receiving quality (RSRQ) or signal to interference plus noise ratio (SINR), such as cell-specific reference signal (CRS)-RSRP/RSRQ or CRS-SINR in long term evolution (LTE), synchronization signal block (SSB)-RSRP/RSRQ or SSB-SINR in new radio (NR), or channel state information reference signal (CSI-RS)-SINR or RS-SINR in sidelink, etc. The reception signal strength may be measured in cell ID (e.g. NCGI/ECGI) level at the primary anchor frequency and/or inter-frequency/unlicensed frequency. The term NCGI refers to NR cell global identifier and the ECGI refers to E-UTRA cell global identifier. The term E-UTRA refers to evolved UMTS terrestrial radio access and the UMTS refers to universal mobile telecommunications system.

As a first option, the future locations of the plurality of maritime vessels may be predicted by using a mobility tracking process. Various existing or future developed target mobility tracking techniques such as Kalman filter based techniques may be used. Take the standard Kalman filter algorithm as an example. Suppose p(t) is the two dimensional (2D) or multiple dimensional GNSS position of a maritime vessel in the maritime network and v(t) is the velocity vector of the maritime vessel. Then, according to Newton's law of motion, it can be obtained that:

$$p ( t ) = p ( t - 1 ) + ( v ( t - 1 ) * Δ t ) + \frac{1}{2} {a ( Δ t )}^{2} \qquad ( 1 )$$

$$v ( t ) = v ( t - 1 ) + a Δ t , \qquad ( 2 )$$

where Δt is the time interval between the time t and the time (t−1) and a is the acceleration of the maritime vessel. The standard Kalman filter equations for the prediction stage are as below:

\hat{x}(t|t−1)=F(t)\hat{x}(t−1|t−1)+B(t)u(t), (3)

P(t|t−1)=E[(x(t)−\hat{x}(t|t−1))(x(t)−\hat{x}(t|t−1))^{T}], (4)

P(t|t−1)=F(t)P(t−1|t−1)F^{T}(t)+Q(t), (5)

where x(t) is

$$[ \begin{matrix}p ( t ) \\ v ( t )\end{matrix} ] ,$$

\hat{x}(t) is an estimate of the state of x(t), F(t) is the state transition matrix which applies the effect of each system state parameter at time (t−1) on the system state at time t, B(t) is the control input matrix, u(t) is the vector containing any control inputs (e.g. steering angle, throttle setting, braking force), P(t) is the variance associated with the prediction and unknown true x(t), the main diagonal of P(t) are the variances associated with the corresponding terms in the state vector, the off-diagonal terms of P(t) provide the covariances between terms in the state vector, and Q(t) is zero mean multivariate normal distribution with covariance given by the covariance matrix.

By comparing equations (1)-(2) and equation (3), it can be obtained that:

$$F ( t ) = [ \begin{matrix}1 & Δ t \\ 0 & 1\end{matrix} ] , \qquad ( 6 )$$

$$B ( t ) = [ \begin{matrix}\frac{1}{2} {( Δ t )}^{2} \\ Δ t\end{matrix} ] . \qquad ( 7 )$$

The Kalman filter equations for the measurement stage are as below:

\hat{x}(t|t)=\hat{x}(t|t−1)+K(t)[(H(t)x(t)+V(t))−H(t)\hat{x}(t|t−1)], (8)

P(t|t)=P(t|t−1)−K(t)H(t)P(t|t−1)^{T}, (9)

K(t)=P(t|t−1)H^{T}(t)(H(t)P(t|t−1)H^{T}(t)+R(t))⁻¹, (10)

where H (t) is the transformation matrix that maps the state vector parameter into the measurement domain, V(t) is the vector containing the measurement noise terms for each observation in the measurement vector and the measurement noise is assumed to be zero mean Gaussian white noise with covariance R(t). By repeatedly performing the prediction and measurement stages for different time instants, \hat{x}(t), P(t) and F(t) can be updated repeatedly. When needing to predict the future location of a maritime vessel, the most recently updated \hat{x}(t) and F(t) can be used for predict the future location by using equation (3). For example, a longer time (minutes or hour level, etc.) of position/velocity may be predicted for a given maritime vessel. Note that it is also possible to predict the acceleration/angle of movement direction for a given maritime vessel by using the Kalman filter algorithm.

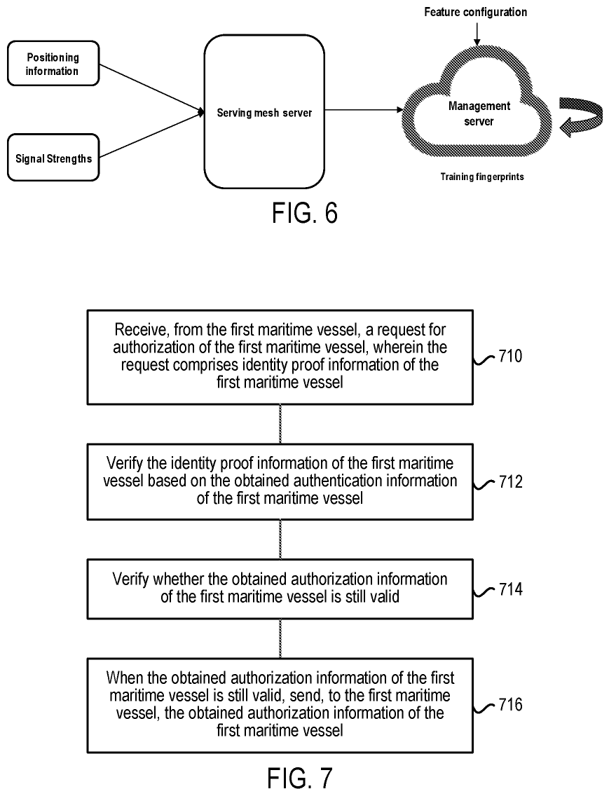

As a second option, the future locations of the plurality of maritime vessels may be predicted by using a machine learning (ML) or artificial intelligence (AI) process. For example, a clustering process such as a K nearest neighbor (KNN) based process may be used. Take weighted KNN (WKNN) algorithm as an example. FIG. 6 illustrates an architecture that may be employed in this example. As shown, for a maritime vessel, its positioning information and reception signal strength (e.g. measured by a CPE on this vessel) may be collected by a mesh server serving (e.g. the CPE on) this vessel. Then, the collected positioning information and reception signal strength may be sent by the serving mesh server to the management server. Note that the positioning information and reception signal strength of all or some of the maritime vessels in the maritime network may be collected and sent to the management server. In the training phase, through feature configuration, the management server may extract values of corresponding features from the received information and convert them into a format file which may be stored in a database. Table 1 below shows exemplary trained feature data stored in the database. Each row of the table may be called a feature of fingerprint. The validation timer for a fingerprint indicates the time elapsed since the fingerprint is generated. The fingerprint may be removed from the database when the elapsed time is greater than a predetermined threshold.

TABLE 1
Format file of trained data feature

| | | | Distance to | Signal Strength to | | |
|---|---|---|---|---|---|---|
| | | | Serving | Serving Vessel | | |
| Latitude | Longitude | Velocity (km/h) | Vessel (km) | [RSRP RSRQ SINR) | Validation Timer | |
| 31.234881 | 121.530909 | 60 | 50 | [−105 dbm 20 db 10 db] | 2 | h |
| 32.234881 | 120.530909 | 80 | 30 | [−90 dbm 10 db 15 b] | 0.5 | h |

| | | | | | |
|---|---|---|---|---|---|
| . . . | . . . | . . . | . . . | . . . | . . . |

Optionally, for a maritime vessel, cell information which is information about the cell serving this vessel, and connection status information which indicates the connection status between the serving cell and its connected neighboring cell(s), may be collected and sent to the management server. With the cell information and the connection status information of every vessel in the maritime network, the topology of the whole maritime network may be obtained by the management server. As an exemplary example, the management server (e.g. in the form of a cloud) may have a front-end responsible for connection management of the maritime network and a back-end (e.g. a data center) responsible for data storage and computation.

In the prediction phase, when a new measurement m including positioning information and reception signal strength is sent to the management server, the management server may extract feature values and convert them into a format file. Then, the similarity D (n) between the new measurement m and the fingerprint f(n) in the database can be calculated as below (in this example, the similarity is based on least mean square (LMS)):

d_{Lat,Log}(n)={square root over (Σ(m_{Lat,Log}−f_{Lat,Log}(n))²/M)}, (11)

d_{Vel,Dis}(n)={square root over (Σ(m_{Vel,Dis}−f_{Vel,Dis}(n))²/M)}, (12)

d_{SS}(n)={square root over (Σ(m_{SS}−f_{SS}(n))²/M)}, (13)

D(n)=αd_{Lat,Log}(n)+βd_{Vel,Dis}(n)+γd_{SS}(n), (14)

where d_{Lat,Log}(n) is the similarity in the aspects of latitude and longitude, M is the number of validated fingerprints in the database, d_{Vel,Dis}(n) is the similarity in the aspects of volicity and distance to serving vessel, d_{SS}(n) is the similarity in the aspect of signal strength to serving vessel, α, βand γ are independent feature factors to balance different feature weights. The D(n) obtained according to formula (14) may be ranked and truncated into length N. Note that it is also possible for the serving mesh server to perform the generation of the format file and the calculation of the similarity.

Then, a predetermined number of fingerprints having the highest similarity values may be selected for further location prediction. Weights W(n) may be determined for these fingerprints according to WKNN algorithm. Then, the predicted location Epos of the maritime vessel may be calculated as:

Epos=Σ₀^{N}(W(n)*f_{Lat,Log}(n)), (15)

where N is the predetermined number of the selected fingerprints. More details about the determination of the weights can be found from, for example, https://en.wikipedia.org/wiki/K-nearest_neighbors_algorithm#The_weighted_nearest_neighbour_classifier. The final predicted location point may be geometric center or mathematical point of Epos, with optionally an uncertainty degree as traditional positioning algorithms. Optionally, considering the maritime routing may be affected by the combined factors of geographical topography, ocean currents, Gulf stream, strait and weather, the location prediction in the prediction phase may be adjusted by these factors. Note that the present disclosure is not limited to the above example of KNN based process. Various other existing or future developed machine learning techniques for location prediction may be used instead.

Referring back to FIG. 5, at block 504, the management server determines whether a disconnection between the first and second maritime vessels is to occur, based on the predicted future locations of the first and second maritime vessels. For example, if the distance between the predicted future locations of the first and second maritime vessels is greater than or equal to a predetermined distance, it may be determined that the disconnection is to occur.

In response to determining that the disconnection is to occur, the management server obtains at block 506, from the first maritime vessel, security related information of the first maritime vessel before the disconnection occurs. For example, the security related information of a given maritime vessel may comprise authentication information of the maritime vessel, and authorization information of the maritime vessel. Examples of the authentication information of the maritime vessel include, but not limited to, public key and private key pair of (e.g. the mesh server and the NFs on) the maritime vessel, a digital certificate of (e.g. the mesh server and the NFs on) the maritime vessel, a digital signature signed by the maritime vessel, authentication vectors, a time stamp identifying the generation of the key pair/certificate/signature, etc. Examples of the authorization information of the maritime vessel include, but not limited to, an authorization (or access) token of (e.g. the NFs and the mesh server on) the maritime vessel, a time stamp identifying the generation of the token, etc. The security related information of the maritime vessel may be obtained from the management server according to existing authentication and authorization procedures during the maritime vessel initially connects to the terrestrial network. The obtained security related information of the vessel may be locally stored for future retrieval for restoration/reestablishment. The management server may inform to the first maritime vessel that the disconnection is to occur, so as to trigger the first maritime vessel to send the security related information. The time at which the security related information of the first maritime vessel is received by the management server may be recorded as a time stamp for further expiration check which will be described later.

Note that the obtaining at block 506 is pre-protection and try-best service behavior, if it is not possible to be finished until the disconnection occurs. Unless otherwise described, when the security related information is sent between two nodes (e.g. between a mesh server and the management server, or between two mesh servers), the plain texts contained in the security related information is encrypted for security enhancement. When the encrypted information is received, it may be stored in a trusted zone (e.g. a secured hardware) on the receiving node. As an option, javascript object notation (JSON) web signature (JWS)/JSON web algorithms (JWA) encryption or other similar encryptions may be used. For example, JWS can represent content secured with digital signatures or message authentication codes (MACs) using JSON-based data structures (see RFC 7519). The JWS compact serialization format may be as below:

BASE64URL(UTF8(JWS Protected Header))∥‘.’∥BASE64URL(JWS Payload)∥‘.’∥BASE64URL(JWS Signature),

where JWS Signing Input=ASCII(BASE64URL(UTF8(JWS Protected Header)) ∥‘.’∥ BASE64URL(JWS Payload)), and the JWS signature is generated with (Hash Algorithm and Key). As an exemplary example, a digital signature of the JWS Signing Input may be generated by using ECDSA P-256 SHA-256 with the desired private key. More details can be found from RFC 7518. Any other suitable mechanisms for representing secured contents may be used instead.

At block 508, when the first maritime vessel reconnects to the terrestrial network, the management server performs a first authorization process for the first maritime vessel based on the obtained security related information of the first maritime vessel. For example, block 508 may be implemented as blocks 710-716 of FIG. 7. At block 710, the management server receives, from the first maritime vessel, a request for authorization of the first maritime vessel. The request comprises identity proof information of the first maritime vessel. As an option, the identity proof information of the first maritime vessel may be a digital signature signed by the first maritime vessel. For example, the digital signature may be generated by the first maritime vessel by encrypting a hash value of the certificate contents with its private key. At block 712, the management server verifies the identity proof information of the first maritime vessel based on the obtained authentication information of the first maritime vessel. For example, the verification may be performed by decrypting the digital signature with the public key of the first maritime vessel that is contained in the obtained authentication information, and checking whether the decrypted hash value is the same as a calculated hash value of the digital certificate contained in the obtained authentication information. In this way, the authentication on the first maritime vessel can be achieved by only two steps (i.e. blocks 710 and 712). This can reduce the signaling overhead required for authentication of the first maritime vessel, when compared with the existing solution where transport layer security (TLS) authentication procedure such as that defined in the Internet engineering task force (IETF) RFC 5246 is performed.

When the verification on the identity proof information of the first maritime vessel is successful, the management server verifies whether the obtained authorization information of the first maritime vessel is still valid at block 714. For example, the verification may be performed by checking the time validity of the access token, i.e. whether the expiration date of the access token contained in the obtained authorization information has passed. If the expiration date of the access token has not passed, it may be determined that the obtained authorization information of the first maritime vessel is still valid. On the other hand, if the expiration date of the access token has passed, it may be determined that the obtained authorization information of the first maritime vessel is not valid. When the obtained authorization information of the first maritime vessel is still valid, the management server sends at block 716, to the first maritime vessel, the obtained authorization information of the first maritime vessel. In this way, for the maritime vessel whose authorization information is still valid, the authorization on this maritime vessel can be achieved by directly sending the obtained authorization information to this maritime vessel as an authorization response. This can reduce the signaling overhead required for authorization of the first maritime vessel.

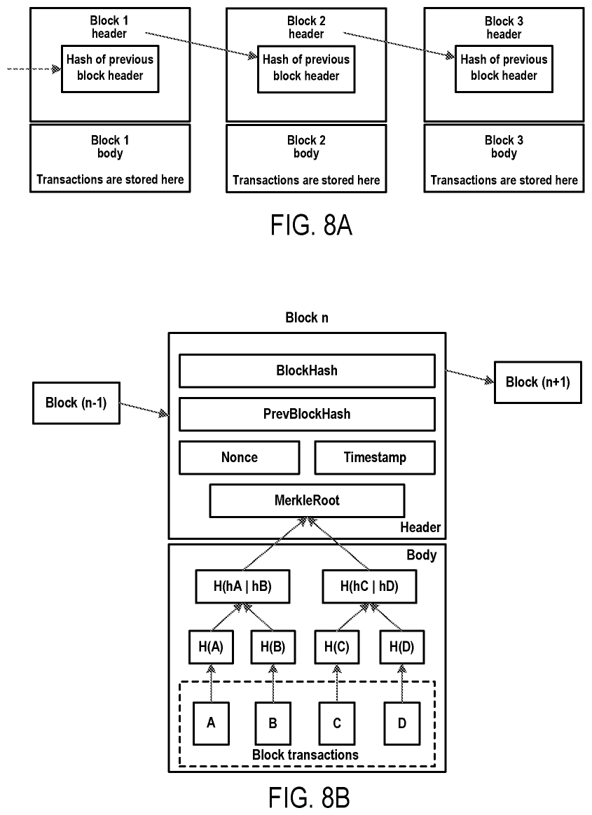

In the above description, the digital signature signed by the first maritime vessel is used as the identity proof information of the first maritime vessel. It should be noted that the present disclosure is not limited to this example. As another option, a blockchain may be utilized for providing the identity proof information. The basic principle of blockchain can be found from, for example, “Applications of Blockchains in the Internet of Things: A Comprehensive Survey” (Muhammad Salek Ali, et al., IEEE Communications Surveys & Tutorials, Vol. 21, No. 2, second quarter 2019). FIG. 8A and FIG. 8B are FIG. 1(a) and FIG. 1(b) of this paper. FIG. 8A illustrates the logical representation of a blockchain. FIG. 8B illustrates block header fields and Merkle tree for storing transactions in a block. As shown in these figures, each block of the chain may comprise a header and a body. The header of each block may contain (among the other fields) the identifier of the previous block, thus forming a chain of blocks (i.e., a blockchain). Transactions are stored within the body of each block, in a data structure called Merkle tree.

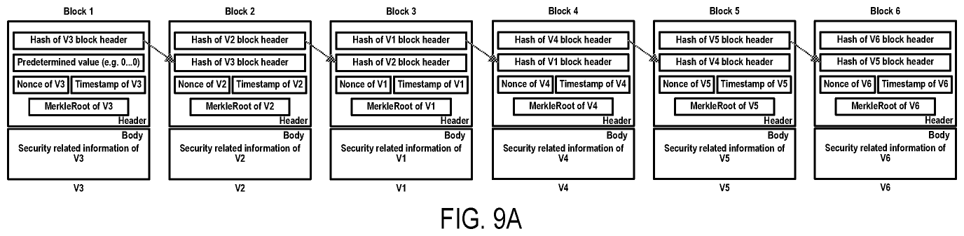

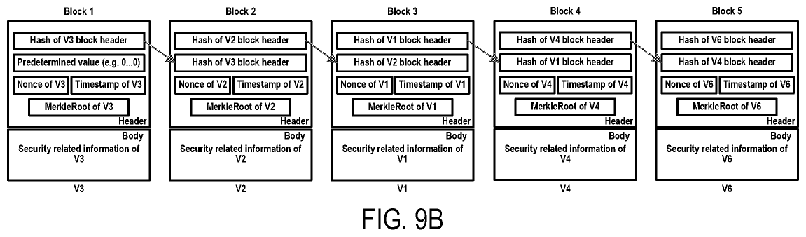

Based on the similarity between the security topology of the maritime network and a blockchain, each block of the blockchain may be considered as one vessel/nodes/hop. FIGS. 9A and 9B illustrate exemplary blockchains usable in the present disclosure. FIG. 9A illustrates a blockchain maintained before the disconnection between V4 and V5 occurs in the scenario shown in FIG. 4A. As shown in FIG. 4A, before the disconnection occurs, there is a chain of V3-V2-V1-V4-V5-V6. Correspondingly, as shown in FIG. 9A, a blockchain having 6 blocks each corresponding to a vessel may be maintained. For example, initially, V3 may generate Block 1. The security related information of V3 may be stored in the body of Block 1. Each record of authentication/authorization information contained in the security related information may include a local time stamp (identifying the generation thereof) and payload information thereof. MerkleRoot of V3 may be calculated from the body of Block 1. Since Block 1 is the first block of the blockchain, a predetermined value (e.g. “0 . . . 0”) may be filled into the field “PrevBlockHash”. The hash value of the header (excluding the field “BlockHash”) of Block 1 may be calculated so as to be filled into the field “BlockHash” of Block 1. Then, V3 may send the header of Block 1 to V2, so that V2 may fill the value of the field “BlockHash” of Block 1 into the field “PrevBlockHash” of Block 2. Similarly, the security related information of V2 may be stored in the body of Block 2. MerkleRoot of V2 may be calculated from the body of Block 2. The hash value of the header (excluding the field “BlockHash”) of Block 2 may be calculated so as to be filled into the field “BlockHash” of Block 2. Then, V2 may send the header of Block 2 to V1, so that V1 may fill the value of the field “BlockHash” of Block 2 into the field “PrevBlockHash” of Block 3. In this way, all of the 6 blocks may be respectively generated on the 6 vessels. Each vessel may maintain the body of its own block and a chain of 6 headers.

FIG. 9B illustrates a blockchain maintained during V4 restores a connection to the terrestrial network via V6 in the scenario shown in FIG. 4B. As shown in FIG. 4B, there is a chain of V3-V2-V1-V4-V6. Compared with the chain shown in FIG. 4A, V5 is removed from the chain shown in FIG. 4B. Thus, the first 4 blocks remain unchanged. V4 may send the header of Block 4 to V6, so that V6 may fill the value of the field “BlockHash” of Block 4 into the field “PrevBlockHash” of Block 5. The security related information of V6 may be stored in the body of Block 5. MerkleRoot of V6 may be calculated from the body of Block 5. The hash value of the header (excluding the field “BlockHash”) of Block 5 may be calculated so as to be filled into the field “BlockHash” of Block 5. This change may be informed to other vessels so that each vessel may maintain the body of its own block and a chain of 5 headers.

It should be noted that the blockchains shown in FIGS. 8A-8B and FIGS. 9A-9B are merely exemplary examples for illustration purpose. It is possible that the field “BlockHash” may be omitted from the header of each block. In this case, when a vessel sends the header of its own block to the next vessel on the chain, the next vessel can calculate a hash value of the received header so as to fill it into the field “PrevBlockHash” of its own block. It is also possible that the field “Nonce” may be omitted from the header of each block. Further, it is also possible that there may be two independent chains, one of which corresponds to network functions (NFs) and the other of which corresponds to application functions (AFs) (e.g. mesh servers).

Based on the above description with reference to FIGS. 9A-9B, there may be a chain of maritime vessels including the first maritime vessel (e.g. V4) and an anchor maritime vessel (e.g. V6) directly connected to the terrestrial network. The security related information of each maritime vessel on the chain may be contained in a block body of a corresponding block of a blockchain, and a block header of the corresponding block may contain a hash value of a previous block header. In this case, the identity proof information of the first maritime vessel may be a block header of a corresponding block of the blockchain. Thanks to the blockchain feature that headers and bodies can hardly be tampered, the verification on the identity proof information may be simplified by simply checking whether the received block header is the same as the corresponding block header in the maintained chain of block headers on the management server. In the example shown in FIGS. 4A-4B, even some attacker disguises itself as fake V4 to V6, or disguises itself as fake V1/V2/V3 to V4, it would be easily discovered and rejected due to the use of blockchain. Note that this is at the cost of blockchain updates needed whenever the topology of the chain changes. Furthermore, the security related information of the first maritime vessel may be obtained at block 506 by receiving the block body of the block generated by the first maritime vessel.

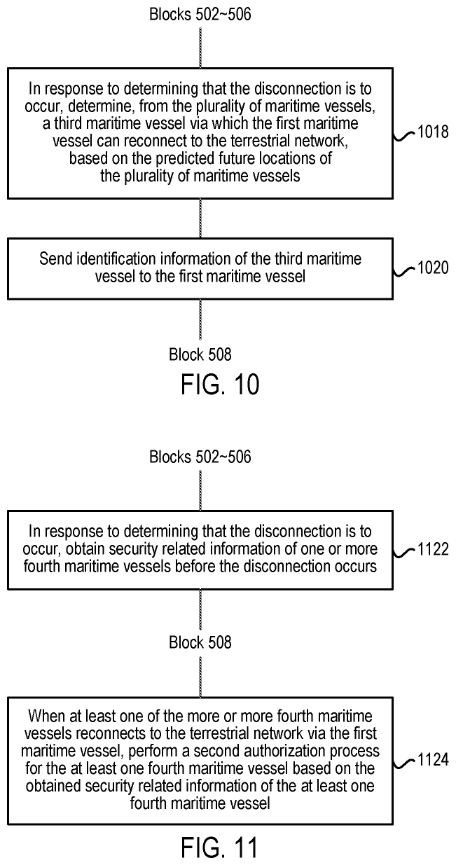

FIG. 10 is a flowchart illustrating a method performed by a management server according to an embodiment of the disclosure. As shown, the method comprises blocks 502-508 described above and blocks 1018-1020. At block 502, the management server predicts future locations of a plurality of maritime vessels based on historical status information of the plurality of maritime vessels. The plurality of maritime vessels comprise a first maritime vessel and a second maritime vessel, and the first maritime vessel is communicatively connected to the terrestrial network via the second maritime vessel. At block 504, the management server determines whether a disconnection between the first and second maritime vessels is to occur, based on the predicted future locations of the first and second maritime vessels. At block 506, in response to determining that the disconnection is to occur, the management server obtains, from the first maritime vessel, security related information of the first maritime vessel before the disconnection occurs.

At block 1018, in response to determining that the disconnection is to occur, the management server determines, from the plurality of maritime vessels, a third maritime vessel via which the first maritime vessel can reconnect to the terrestrial network, based on the predicted future locations of the plurality of maritime vessels. For example, if the predicted location of a ship is in proximity to that of the first maritime vessel and can allow the ship to still maintain its connection to the terrestrial network, then the ship may be determined as the third maritime vessel. At block 1020, the management server sends identification information of the third maritime vessel to the first maritime vessel. In this way, the time required by the first maritime vessel for restoring its connection to the terrestrial network can be reduced since the first maritime vessel can know which target vessel to connect with. Note that the determination of the target vessel is applied for mobility robustness and security purpose, and thus may be independent with any control plane (CP) or user plane (UP) anchor node (e.g. a node on T0) selection procedure. At block 508, when the first maritime vessel reconnects to the terrestrial network, the management server performs a first authorization process for the first maritime vessel based on the obtained security related information of the first maritime vessel.

FIG. 11 is a flowchart illustrating a method performed by a management server according to an embodiment of the disclosure. The method is applicable to a scenario where a plurality of maritime vessels comprise a first maritime vessel and a second maritime vessel, the first maritime vessel is communicatively connected to a terrestrial network via the second maritime vessel, and the plurality of maritime vessels further comprise one or more fourth maritime vessels which are communicatively connected to the terrestrial network via the first maritime vessel. The plurality of maritime vessels may be all of maritime vessels in a maritime network, or may be only a portion thereof. As shown, the method comprises blocks 502-508 described above and blocks 1122-1124. At block 502, the management server predicts future locations of the plurality of maritime vessels based on historical status information of the plurality of maritime vessels. At block 504, the management server determines whether a disconnection between the first and second maritime vessels is to occur, based on the predicted future locations of the first and second maritime vessels. At block 506, in response to determining that the disconnection is to occur, the management server obtains, from the first maritime vessel, security related information of the first maritime vessel before the disconnection occurs.

At block 1122, in response to determining that the disconnection is to occur, the management server obtains security related information of the one or more fourth maritime vessels before the disconnection occurs. As described above, the security related information of the one or more fourth maritime vessels may comprise authentication information of the one or more fourth maritime vessels, and authorization information of the one or more fourth maritime vessels. As an option, when the management server informs to the first maritime vessel that the disconnection is to occur, the first maritime vessel may obtain, from the one or more fourth maritime vessels, the security related information thereof. Then, the security related information of the one or more fourth maritime vessels may be received from the first maritime vessel together with the security related information of the first maritime vessel. In this case, block 506 and block 1122 are performed concurrently. As another option, independently of block 506, the management server may respectively request each of the one or more fourth maritime vessels to send the security related information thereof to the management server.

At block 508, when the first maritime vessel reconnects to the terrestrial network, the management server performs a first authorization process for the first maritime vessel based on the obtained security related information of the first maritime vessel. For example, block 508 may be implemented as blocks 710-716 of FIG. 7. At block 710, the management server receives, from the first maritime vessel, a request for authorization of the first maritime vessel. The request comprises identity proof information of the first maritime vessel. At block 712, the management server verifies the identity proof information of the first maritime vessel based on the obtained authentication information of the first maritime vessel. When the verification on the identity proof information of the first maritime vessel is successful, the management server verifies whether the obtained authorization information of the first maritime vessel is still valid at block 714. When the obtained authorization information of the first maritime vessel is still valid, the management server sends at block 716, to the first maritime vessel, the obtained authorization information of the first maritime vessel.

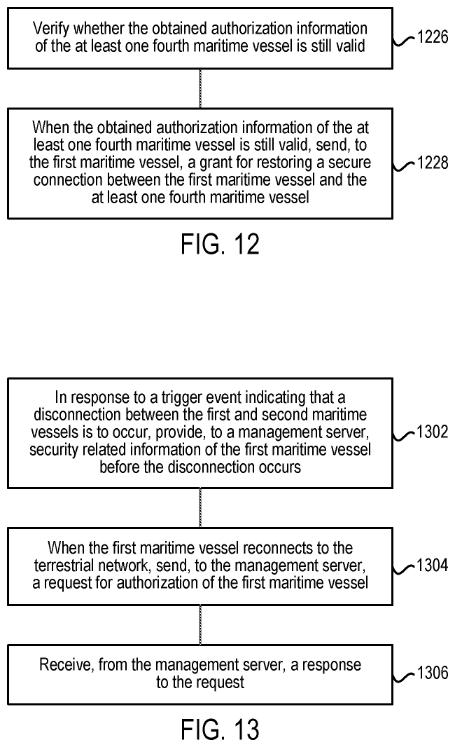

At block 1124, when at least one of the more or more fourth maritime vessels reconnects to the terrestrial network via the first maritime vessel, the management server performs a second authorization process for the at least one fourth maritime vessel based on the obtained security related information of the at least one fourth maritime vessel. The at least one fourth maritime vessel may refer to the fourth maritime vessel(s) which still maintain the same topology as before the occurrence of the disconnection between the first and second maritime vessels. For example, block 1124 may be implemented as block 710 and blocks 1226-1228 of FIG. 12. That is, when block 1124 is performed, it may share the same block 710 with block 508. In this case, the request for authorization of the first maritime vessel may further indicate that the at least one fourth maritime vessel requires authorization by the management server.

At block 1226, the management server verifies whether the obtained authorization information of the at least one fourth maritime vessel is still valid. For example, the verification may be performed by checking whether the expiration date of the access token contained in the obtained authorization information has passed. If the expiration date of the access token has not passed, it may be determined that the obtained authorization information of the at least one fourth maritime vessel is still valid. On the other hand, if the expiration date of the access token has passed, it may be determined that the obtained authorization information of the at least one fourth maritime vessel is not valid.

At block 1228, when the obtained authorization information of the at least one fourth maritime vessel is still valid, the management server sends, to the first maritime vessel, a grant for restoring a secure connection between the first maritime vessel and the at least one fourth maritime vessel. For example, the grant may contain the obtained authentication information (especially the private key) of the at least one fourth maritime vessel. With the received grant, the first management server may act as a trusted node to further restore the secure connection for the at least one fourth maritime vessel. This can reduce the signaling overhead and re-AAA latency required for authorization of the at least one fourth maritime vessel, when compared with the existing solution where the management server respectively performs an authorization procedure for each of the at least one fourth maritime vessel.

FIG. 13 is a flowchart illustrating a method performed by a first server on a first maritime vessel according to an embodiment of the disclosure. The method is applicable to a communication network including a maritime network and a terrestrial network. The maritime network may comprise multiple maritime vessels each of which is provided with a base station and a server. Among the multiple maritime vessels, the first maritime vessel is communicatively connected to a terrestrial network via a second maritime vessel. At block 1302, in response to a trigger event indicating that a disconnection between the first and second maritime vessels is to occur, the first server provides, to a management server, security related information of the first maritime vessel before the disconnection occurs. For example, the server on the maritime vessel directly connected with the terrestrial network, or a server on land or a fixed offshore platform, may act as the management server. The trigger event may be an event that a notification informing that the disconnection is to occur, or a request for retrieving the security related information, is received from the management server. As described above, the security related information of the first maritime vessel may comprise authentication information of the first maritime vessel, and authorization information of the first maritime vessel.

At block 1304, when the first maritime vessel reconnects to the terrestrial network, the first server sends, to the management server, a request for authorization of the first maritime vessel. For example, the request may comprise identity proof information of the first maritime vessel. As described above, the identity proof information of the first maritime vessel may be a digital signature signed by the first maritime vessel, or a block header of a corresponding block of a blockchain. The blockchain corresponds to a chain of maritime vessels including the first maritime vessel and an anchor maritime vessel directly connected to the terrestrial network. The security related information of each maritime vessel on the chain is contained in a block body of a corresponding block of the blockchain, and a block header of the corresponding block contains a hash value of a previous block header. Because the identity proof information of the first maritime vessel is contained in the request, it is possible for the management server to authenticate the first maritime vessel based on the authentication information of the first maritime vessel that is provided to the management server by the first server.

At block 1306, the first server receives, from the management server, a response to the request. For example, the response to the request may comprise the authorization information of the first maritime vessel that is provided to the management server by the first server. As described above, this means the authorization on the first maritime vessel can be achieved by the management server by directly sending the previously obtained authorization information to the first maritime vessel as an authorization response. Based on the above description, with the method of FIG. 13, it is possible to reduce the signaling overhead required for authorization of the first maritime vessel since the security related information thereof is provided to the management server in advance.

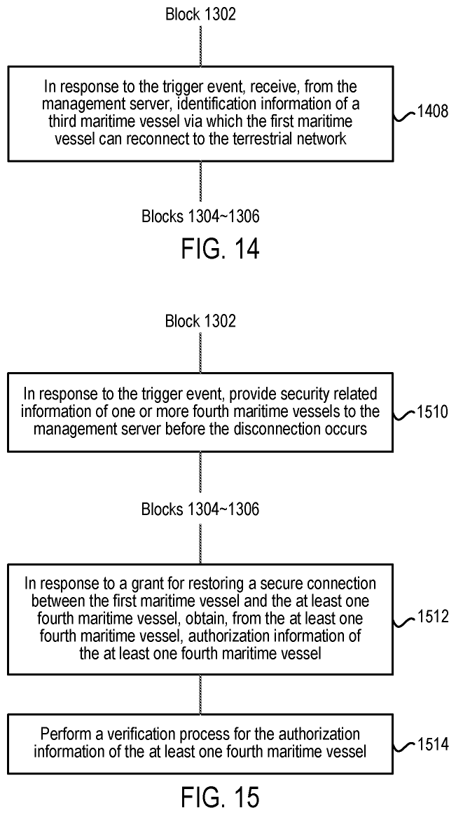

FIG. 14 is a flowchart illustrating a method performed by a first server on a first maritime vessel according to an embodiment of the disclosure. As shown, the method comprises blocks 1302-1306 described above and block 1408. At block 1302, in response to a trigger event indicating that a disconnection between the first and second maritime vessels is to occur, the first server provides, to a management server, security related information of the first maritime vessel before the disconnection occurs. At block 1408, in response to the trigger event, the first server receives, from the management server, identification information of a third maritime vessel via which the first maritime vessel can reconnect to the terrestrial network. Based on the received identification information, the first server may connect to the third maritime vessel so as to restore the connection to the terrestrial network. In this way, the time required by the first maritime vessel for restoring its connection to the terrestrial network can be reduced since the first maritime vessel can know which target vessel to connect with. At block 1304, when the first maritime vessel reconnects to the terrestrial network, the first server sends, to the management server, a request for authorization of the first maritime vessel. At block 1306, the first server receives, from the management server, a response to the request.

FIG. 15 is a flowchart illustrating a method performed by a first server on a first maritime vessel according to an embodiment of the disclosure. The method is applicable to a scenario where a plurality of maritime vessels comprise a first maritime vessel and a second maritime vessel, the first maritime vessel is communicatively connected to a terrestrial network via the second maritime vessel, and the plurality of maritime vessels further comprise one or more fourth maritime vessels which are communicatively connected to the terrestrial network via the first maritime vessel. The plurality of maritime vessels may be all of maritime vessels in a maritime network, or may be only a portion thereof. As shown, the method comprises blocks 1302-1306 described above and blocks 1510-1514. At block 1302, in response to a trigger event indicating that a disconnection between the first and second maritime vessels is to occur, the first server provides, to a management server, security related information of the first maritime vessel before the disconnection occurs.

At block 1510, in response to the trigger event, the first server provides security related information of the one or more fourth maritime vessels to the management server before the disconnection occurs. As described above, the security related information of the one or more fourth maritime vessels may comprise authentication information of the one or more fourth maritime vessels, and authorization information of the one or more fourth maritime vessels. As an option, when the management server informs to the first server that the disconnection is to occur, the first server may obtain, from the one or more fourth maritime vessels, the security related information thereof. Then, the security related information of the one or more fourth maritime vessels may be sent to the management server together with the security related information of the first maritime vessel. In this case, block 1302 and block 1510 are performed concurrently. As another option, independently of block 1302, the management server may respectively request each of the one or more fourth maritime vessels to send the security related information thereof to the management server. In this case, block 1510 may be performed by forwarding the security related information of the one or more fourth maritime vessels to the management server.

At block 1304, when the first maritime vessel reconnects to the terrestrial network, the first server sends, to the management server, a request for authorization of the first maritime vessel. As described above, the request may comprise identity proof information of the first maritime vessel. In a case where at least one of the one or more fourth maritime vessels still maintains the same topology as before the occurrence of the disconnection between the first and second maritime vessels, the request may further indicate that the at least one fourth maritime vessels requires authorization by the management server. At block 1306, the first server receives, from the management server, a response to the request. As described above, the response to the request may comprise the authorization information of the first maritime vessel that is provided to the management server by the first server. The response to the request may further comprise a grant for restoring a secure connection between the first maritime vessel and the at least one fourth maritime vessel. The grant may contain the authentication information (especially the private key) of the at least one fourth maritime vessel. With the received grant, the first management server may act as a trusted node to further restore the secure connection for the at least one fourth maritime vessel.

At block 1512, in response to the grant, the first maritime vessel obtains, from the at least one fourth maritime vessel, authorization information of the at least one fourth maritime vessel. As an option, the authorization information of the at least one fourth maritime vessel may be received in an unencrypted form. This option is suitable for a scenario where no disconnection occurs between the at least one fourth maritime vessel and the first maritime vessel during the first maritime vessel disconnects from the second maritime vessel and then restores a connection to the terrestrial network. The use of the unencrypted form in this scenario can reduce the time required for restoring the secure connection for the at least one fourth maritime vessel since there is no need for the first server to perform decryption. Thus, this option may also be referred to as speed mode.

As another option, the authorization information of each of the at least one fourth maritime vessel may be respectively received from corresponding fourth maritime vessel in an encrypted form. For example, the encrypted form may be obtained by a public key of the corresponding fourth maritime vessel. This option is suitable for a scenario where an abnormality occurs (e.g. a disconnection occurs between the at least one fourth maritime vessel and the first maritime vessel, a cyber-attack happens and is detected by the management server) during the first maritime vessel disconnects from the second maritime vessel and then restores a connection to the terrestrial network. The use of the encrypted form in this scenario may be based on a tradeoff between stricter security criterion and longer restoration/reestablishment time (or more AAA messages) in the maritime network. Thus, this option may also be referred to as security mode.

At block 1514, the first server performs a verification process for the authorization information of the at least one fourth maritime vessel. For the option that may also be called speed mode, the verification process may be performed by checking whether the expiration date of the access token contained in the authorization information has passed. If the expiration date of the access token has not passed, it may be determined that the authorization information of the at least one fourth maritime vessel is still valid. On the other hand, if the expiration date of the access token has passed, it may be determined that the authorization information of the first maritime vessel is not valid. For the option that may also be called security mode, the verification process comprises decrypting the authorization information of each of the at least one fourth maritime vessel based on the grant from the management server. For example, the authorization information of each of the at least one fourth maritime vessel may be decrypted based on a private key of the corresponding fourth maritime vessel which is contained in the grant from the management server. Then, the decrypted authorization information may be verified in a way similar to that described for the speed mode.

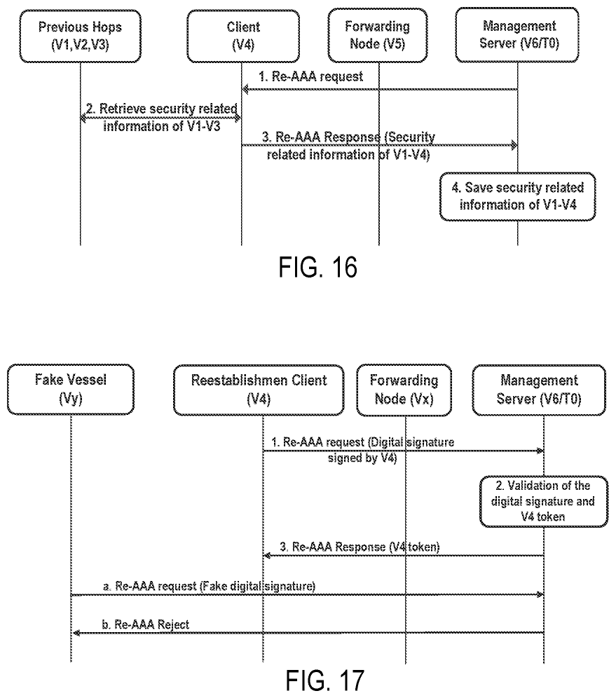

FIG. 16 is a diagram illustrating an exemplary process according to an embodiment of the disclosure. Suppose the management server has predicted that a disconnection between V4 and V5 is to occur in the scenario shown in FIG. 4A. In response to this, the process is performed before the disconnection occurs. At step 1, the management server sends a Re-AAA Request to V4. Upon receipt of this request, V4 knows that a disconnection is to occur between itself and V5. At step 2, security related information of V1-V3 is retrieved by V4. For example, a cascaded retrieval may be performed as below: V4 may send a retrieval request to V1 which may, in turn, send a retrieval request to V2; V2 may also send a retrieval request to V3; in response, V2 receives the security related information of V3 and sends it together with the security related information of V2 to V1; then, V1 sends the received security related information of V2 and V3 together with the security related information of V1 to V4.

At step 3, V4 sends the security related information of V1-V4 to the management server in a Re-AAA Response, where the security related information of V3 may be digitally signed by V2, the security related information of V2 may be digitally signed by V1, the security related information of V1 may be digitally signed by V4, and the security related information of V4 may be digitally signed by V4. At step 4, the management server saves the received security related information of V1-V4. Note that if V1, V2 and V3 do not exist, step 2 will be omitted and only the security related information of V4 will be sent to the management server. In addition, although not shown in FIG. 16, it is also possible to perform a centralized retrieval instead of the cascaded retrieval. For example, the management server may respectively send a retrieval request to each of V4, V1, V2 and V3. In response, the security related information of V4, V1, V2 and V3 may be respectively sent to the management server.

FIG. 17 is a diagram illustrating an exemplary process according to an embodiment of the disclosure. Suppose the management server has determined that V4 can reconnect to the terrestrial network via V6 in the scenario shown in FIG. 4B. Also suppose the management server has informed identification information of V6 to V4 (e.g. in the Re-AAA Request shown in FIG. 16). In response to the occurrence of the disconnection between V4 and V5, the process is performed which only involves the restoration of the connection from V4 to the management server. At step 1, when V4 searches for signals from V6 and radio resource control (RRC) connection reestablishment succeeds between CPE4 on V4 and the mesh server 6 on V6, V4 (e.g. the mesh server 4 on V4) sends, to the management server, a Re-AAA Request containing a digital signature signed by V4. At step 2, the management server performs validation on the digital signature signed by V4 and an access token of V4 (simply referred to as V4 token) contained in the retrieved security related information. This may be done as described above with respect to blocks 712 and 714. In this way, the conventional authentication of packet core 4 (PC4) and mesh server 4 (Mesh4) via TLS1.x and NFs discovery can be omitted and the conventional authorization of NFs (e.g. PC4) and the conventional authorization of application functions (AFs) (e.g. Mesh4) can be simplified. Suppose V4 token is still valid. Then, at step 3, the management server sends, to V4, a Re-AAA Response containing V4 token as an authorization response. If the elapsed time shows that V4 token has expired, V6 triggers Re-AAA for V4.

In the above example, the target vessel via which V4 can reconnect to the terrestrial network and the vessel which may be provided with the management server happen to be the same vessel V6 (i.e. the forwarding node Vx does not exist). Note that they may be different vessels with each other. In that case, there will be forwarding node(s) which forwards messages between V4 and the management server.

Suppose a fake vessel Vy intends to disguise itself as V4. Since Vy does not have the private key of V4, the digital signature signed by Vy is a fake digital signature. At step a, this fake digital signature is sent in a Re-AAA Request from Vy to the management server. Due to the fake digital signature, the management server cannot decrypt the fake digital signature with the public key of V4. Thus, a Re-AAA Reject is sent from the management server to Vy.

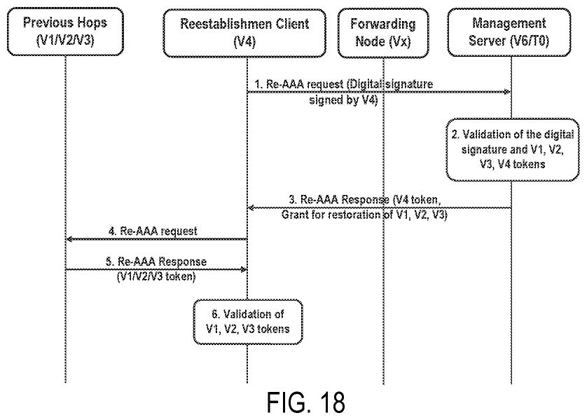

FIG. 18 is a diagram illustrating an exemplary process according to an embodiment of the disclosure. The process of FIG. 18 differs from the process of FIG. 17 in that the restoration of speed mode for V1, V2 and V3 is also involved. At step 1, V4 sends, to the management server, a Re-AAA Request which contains a digital signature signed by V4 and also indicates that V1, V2 and V3 also require authorization. For example, the Re-AAA Request may indicate, for each of V1, V2 and V3, a request type (e.g. the requested token type), a service requester and a service provider. At step 2, the management server performs validation on the digital signature signed by V4 as well as V1 token, V2 token, V3 token and V4 token contained in the retrieved security related information. This may be done as described above with respect to blocks 712, 714 and 1226. Suppose V1-V4 tokens are still valid. Then, at step 3, the management server sends, to V4, a Re-AAA Response containing V4 token and a grant for restoration of V1-V3.

At step 4, V4 respectively sends a Re-AAA Request to each of V1, V2 and V3. At step 5, V4 respectively receives a Re-AAA response containing the corresponding token from each of V1, V2 and V3. It is also possible that V4 may send a Re-AAA Request to V1 which is directly connected with V4. Then, V1 may send a retrieval request to V2 which may, in turn, send a retrieval request to V3. In response, V2 may receive V3 token and send it together with V2 token to V1. Then, V1 may send, to V4, a Re-AAA Response containing V1-V3 tokens. At step 6, V4 performs validation on V1-V3 tokens. This may be done as described above with respect to block 1226. If any one of V1-V3 tokens is validated as still valid, V4 may send a Re-Ack to the corresponding vessel. If any one of V1-V3 tokens is validated as invalid, V4 may inform the validation failure of the corresponding vessel to the management server (e.g. V6/T0) and this vessel may request the management server to perform a new AAA for this vessel.

Note that if the topology of the previous hops of V4 changes during the disconnection and restoration, the restoration procedure described above shall only cover the node(s) with unchanged topology. For example, if a new vessel V0's access succeeds during this time period, it shall not be trusted as a restoration node. V6 shall trigger a new AAA between V0 and V6 when the link is recovered.

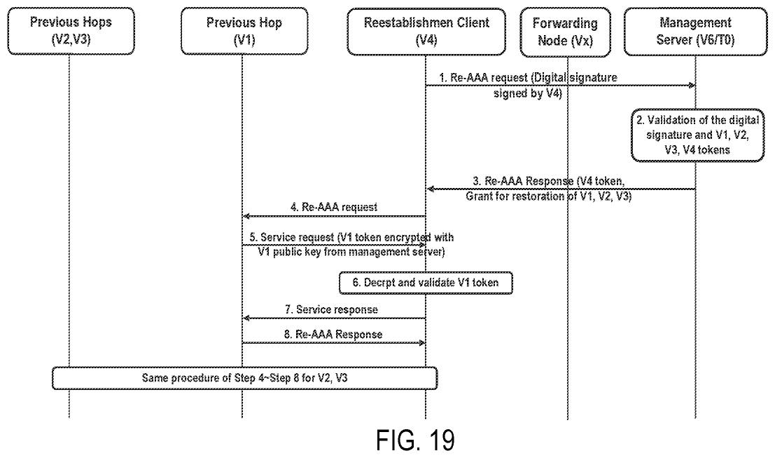

FIG. 19 is a diagram illustrating an exemplary process according to an embodiment of the disclosure. The process of FIG. 19 differs from the process of FIG. 17 in that the restoration of security mode for V1, V2 and V3 is also involved. Steps 1-3 of FIG. 19 is the same as those of FIG. 18 and their details are omitted here. At step 4, V4 sends a Re-AAA Request to V 1. At step 5, V1 sends, to V4, a Service Request containing V1 token encrypted with V1 public key which was issued previously from the management server. At step 6, V4 decrypts the encrypted V1 token with V1 private key contained in the grant from the management server, and performs validation on the decrypted V1 token. At step 7, V4 sends a service response to V1. At step 8, V1 sends a Re-AAA Response to V4. If V1 token is validated as still valid, the service response and the Re-AAA Response may simply acknowledge the service request and the Re-AAA Request respectively. If V1 token is validated as invalid, V4 may indicate a failure cause in the service response to V1. Depending on the specific indication of the failure cause, it is possible that steps 5-7 may be performed again. It is also possible that V4 may inform the validation failure of V1 to the management server (e.g. V6/T0) and V1 may request the management server to perform a new AAA for V1. Then, the same procedure of steps 4-8 is performed for each of V2 and V3 respectively.

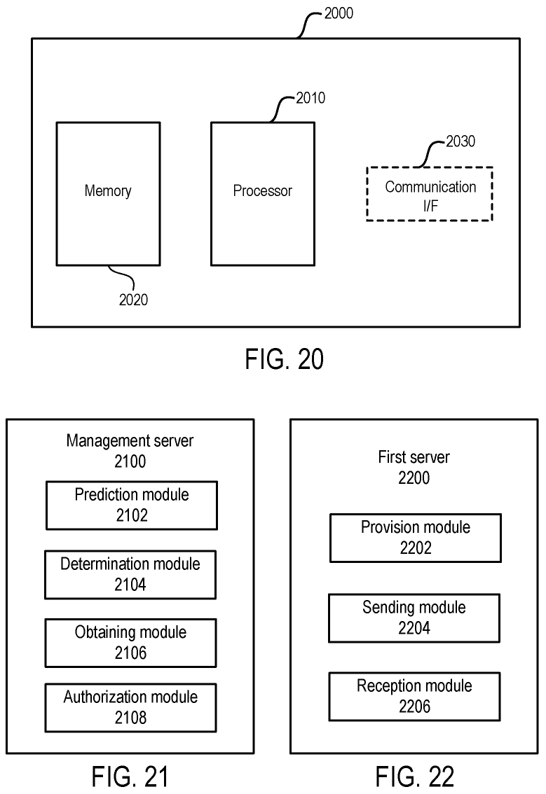

FIG. 20 is a block diagram showing an apparatus suitable for use in practicing some embodiments of the disclosure. For example, any one of the management server and the first server described above may be implemented through the apparatus 2000. As shown, the apparatus 2000 may include a processor 2010, a memory 2020 that stores a program, and optionally a communication interface 2030 for communicating data with other external devices through wired and/or wireless communication.

The program includes program instructions that, when executed by the processor 2010, enable the apparatus 2000 to operate in accordance with the embodiments of the present disclosure, as discussed above. That is, the embodiments of the present disclosure may be implemented at least in part by computer software executable by the processor 2010, or by hardware, or by a combination of software and hardware.

The memory 2020 may be of any type suitable to the local technical environment and may be implemented using any suitable data storage technology, such as semiconductor based memory devices, flash memories, magnetic memory devices and systems, optical memory devices and systems, fixed memories and removable memories. The processor 2010 may be of any type suitable to the local technical environment, and may include one or more of general purpose computers, special purpose computers, microprocessors, digital signal processors (DSPs) and processors based on multi-core processor architectures, as non-limiting examples.

FIG. 21 is a block diagram showing a management server according to an embodiment of the disclosure. As shown, the management server comprises a prediction module 2102, a determination module 2104, an obtaining module 2106 and an authorization module 2108. The prediction module 2102 may be configured to predict future locations of a plurality of maritime vessels based on historical status information of the plurality of maritime vessels, as described above with respect to block 502. The plurality of maritime vessels comprise a first maritime vessel and a second maritime vessel. The first maritime vessel is communicatively connected to a terrestrial network via the second maritime vessel. The determination module 2104 may be configured to determine whether a disconnection between the first and second maritime vessels is to occur, based on the predicted future locations of the first and second maritime vessels, as described above with respect to block 504. The obtaining module 2106 may be configured to, in response to determining that the disconnection is to occur, obtain, from the first maritime vessel, security related information of the first maritime vessel before the disconnection occurs, as described above with respect to block 506. The authorization module 2108 may be configured to, when the first maritime vessel reconnects to the terrestrial network, perform a first authorization process for the first maritime vessel based on the obtained security related information of the first maritime vessel, as described above with respect to block 508.

FIG. 22 is a block diagram showing a first server on a first maritime vessel according to an embodiment of the disclosure. The first maritime vessel is communicatively connected to a terrestrial network via a second maritime vessel. As shown, the first server 2200 comprises a provision module 2202, a sending module 2204 and a reception module 2206. The provision module 2202 may be configured to, in response to a trigger event indicating that a disconnection between the first and second maritime vessels is to occur, provide, to a management server, security related information of the first maritime vessel before the disconnection occurs, as described above with respect to block 1302. The sending module 2204 may be configured to, when the first maritime vessel reconnects to the terrestrial network, send, to the management server, a request for authorization of the first maritime vessel, as described above with respect to block 1304. The reception module 2206 may be configured to receive, from the management server, a response to the request, as described above with respect to block 1306. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

What is claimed is:

1. A method performed by a management server, comprising:
predicting future locations of a plurality of maritime vessels based on historical status information of the plurality of maritime vessels, wherein the plurality of maritime vessels comprise a first maritime vessel and a second maritime vessel, and the first maritime vessel is communicatively connected to a terrestrial network via the second maritime vessel;
determining whether a disconnection between the first and second maritime vessels is to occur, based on the predicted future locations of the first and second maritime vessels;
in response to determining that the disconnection is to occur, obtaining, from the first maritime vessel, security related information of the first maritime vessel before the disconnection occurs; and
when the first maritime vessel reconnects to the terrestrial network, performing a first authorization process for the first maritime vessel based on the obtained security related information of the first maritime vessel.

2. The method according to claim 1, further comprising:
in response to determining that the disconnection is to occur, determining, from the plurality of maritime vessels, a third maritime vessel via which the first maritime vessel can reconnect to the terrestrial network, based on the predicted future locations of the plurality of maritime vessels; and
sending identification information of the third maritime vessel to the first maritime vessel.

3. The method according to claim 1, wherein the security related information of the first maritime vessel comprises authorization information of the first maritime vessel; and
wherein performing the first authorization process for the first maritime vessel comprises:
verifying whether the obtained authorization information of the first maritime vessel is still valid; and
when the obtained authorization information of the first maritime vessel is still valid, sending, to the first maritime vessel, the obtained authorization information of the first maritime vessel.

4. The method according to claim 1, wherein the security related information of the first maritime vessel comprises authentication information of the first maritime vessel; and
wherein performing the first authorization process for the first maritime vessel comprises:
receiving, from the first maritime vessel, a request for authorization of the first maritime vessel, wherein the request comprises identity proof information of the first maritime vessel; and
verifying the identity proof information of the first maritime vessel based on the obtained authentication information of the first maritime vessel.

5. The method according to claim 1, wherein the plurality of maritime vessels comprise one or more fourth maritime vessels which are communicatively connected to the terrestrial network via the first maritime vessel; and
wherein the method further comprises:
in response to determining that the disconnection is to occur, obtaining security related information of the one or more fourth maritime vessels before the disconnection occurs; and
when at least one of the more or more fourth maritime vessels reconnects to the terrestrial network via the first maritime vessel, performing a second authorization process for the at least one fourth maritime vessel based on the obtained security related information of the at least one fourth maritime vessel.

6. The method according to claim 5, wherein the security related information of the one or more fourth maritime vessels comprises authorization information of the one or more fourth maritime vessels; and
wherein performing the second authorization process for the at least one fourth maritime vessel comprises:
verifying whether the obtained authorization information of the at least one fourth maritime vessel is still valid; and
when the obtained authorization information of the at least one fourth maritime vessel is still valid, sending, to the first maritime vessel, a grant for restoring a secure connection between the first maritime vessel and the at least one fourth maritime vessel.

7. The method according to claim 4, wherein the identity proof information of the first maritime vessel comprises: a digital signature signed by the first maritime vessel.

8. The method according to claim 1, wherein there is a chain of maritime vessels including the first maritime vessel and an anchor maritime vessel directly connected to the terrestrial network; and
wherein the security related information of each maritime vessel on the chain is contained in a block body of a corresponding block of a blockchain, and a block header of the corresponding block contains a hash value of a previous block header.

9. The method according to claim 8, wherein identity proof information of a maritime vessel on the chain comprises: a block header of a corresponding block of the blockchain.

10. The method according to claim 1, wherein the future locations of the plurality of maritime vessels are predicted by using a mobility tracking process.

11. The method according to claim 1, wherein the future locations of the plurality of maritime vessels are predicted by using a machine learning process.

12. The method according to claim 11, wherein the machine learning process comprises a clustering process.

13. The method according to claim 1, wherein the historical status information of the plurality of maritime vessels comprises:
historical positioning information of the plurality of maritime vessels; and/or
historical reception signal strength of the plurality of maritime vessels.

14. A method performed by a first server on a first maritime vessel, wherein the first maritime vessel is communicatively connected to a terrestrial network via a second maritime vessel, the method comprising:
in response to a trigger event indicating that a disconnection between the first and second maritime vessels is to occur, providing, to a management server, security related information of the first maritime vessel before the disconnection occurs;
when the first maritime vessel reconnects to the terrestrial network, sending, to the management server, a request for authorization of the first maritime vessel; and
receiving, from the management server, a response to the request.

15. The method according to claim 14, further comprising:
in response to the trigger event, receiving, from the management server, identification information of a third maritime vessel via which the first maritime vessel can reconnect to the terrestrial network.

16. The method according to claim 14, wherein the security related information of the first maritime vessel comprises authorization information of the first maritime vessel; and
wherein the response to the request comprises the authorization information of the first maritime vessel that is provided to the management server by the first server.

17. The method according to claim 14, wherein the security related information of the first maritime vessel comprises authentication information of the first maritime vessel; and
wherein the request comprises identity proof information of the first maritime vessel.

18. The method according to claim 14, wherein one or more fourth maritime vessels are communicatively connected to the terrestrial network via the first maritime vessel; and
wherein the method further comprises: in response to the trigger event, providing security related information of the one or more fourth maritime vessels to the management server before the disconnection occurs.

19. The method according to claim 18, wherein the request further indicates that at least one of the more or more fourth maritime vessels requires authorization by the management server.

20.-27. (canceled)

28. A management server comprising:
at least one processor; and
at least one memory, the at least one memory containing instructions executable by the at least one processor, whereby the management server is operative to:
predict future locations of a plurality of maritime vessels based on historical status information of the plurality of maritime vessels, wherein the plurality of maritime vessels comprise a first maritime vessel and a second maritime vessel, and the first maritime vessel is communicatively connected to a terrestrial network via the second maritime vessel;
determine whether a disconnection between the first and second maritime vessels is to occur, based on the predicted future locations of the first and second maritime vessels;
in response to determining that the disconnection is to occur, obtain, from the first maritime vessel, security related information of the first maritime vessel before the disconnection occurs; and
when the first maritime vessel reconnects to the terrestrial network, perform a first authorization process for the first maritime vessel based on the obtained security related information of the first maritime vessel.

29.-32. (canceled)
